(19) United States
(12) Patent Application Publication
(10) Pub. No.: US 2026/0335801 A1
(43) Pub. Date: Oct. 29, 2026

(54) METHOD FOR CEMENT MANUFACTURING WITH LOCK DEVICES, FILTER SYSTEM AND CEMENT MANUFACTURE PLANT

(71) Applicant: SCHEUCH MANAGEMENT HOLDING GMBH, Aurolzmünster (AT)

(72) Inventors: Holger REINHOLD, Aistersheim (AT); Uwe NEUMANN, Rodenberg (DE)

(21) Appl. No.: 18/998,973

(22) PCT Filed: Aug. 3, 2023
(86) PCT No.: PCT/AT2023/060260

§ 371 Date: Jan. 27, 2025

(30) Foreign Application Priority Data
Aug. 3, 2022 (AT) A 50584/2022

(51) Int. Cl. B01D 45/18; B01D 46/48; C04B 7/36; C04B 7/43; F27D 17/20

(52) U.S. Cl. CPC B01D 45/18; B01D 46/48; C04B 7/364; C04B 7/436; F27D 17/20

(57) ABSTRACT

The invention relates to a method for discharging dust from a filter system in a cement manufacture plant, in which raw materials for the production of cement are fired in a furnace system, the flue gas produced is dedusted in the filter system with a filter device and accumulated dust is discharged via a discharge opening of the filter device, wherein two lock devices, in particular rotary valves, are connected in series to the discharge opening, which are connected to each other via a connecting element, in particular a connecting pipe, and transport the accumulated dust from the discharge opening to the outside, wherein a sealing gas inlet opens into the connecting element between the lock devices and a sealing gas is introduced into the connecting element in order to block the penetration of ambient air into the filter device.

### CROSS REFERENCE TO RELATED APPLICATIONS

The present application is a U.S. National Phase of International Application No. PCT/AT2023/060260 entitled “METHOD FOR PRODUCING CEMENT WITH SLUICE DEVICES, FILTER SYSTEM AND CEMENT PRODUCTION SYSTEM,” and filed on Aug. 3, 2023. International Application No. PCT/AT2023/060260 claims priority to Austrian Patent Application No. A 50584/2022 filed on Aug. 3, 2022. The entire contents of each of the above-listed applications are hereby incorporated by reference for all purposes.

### TECHNICAL FIELD

The invention relates to a method for discharging dust from a filter system in a cement manufacture plant, in which raw materials for the production of cement are fired in a furnace system, the flue gas produced is dedusted in the filter system with a filter device and accumulated dust is discharged via a discharge opening of the filter device.

### BACKGROUND AND SUMMARY

Furthermore, the invention relates to a filter system for dedusting flue gas from a cement manufacture plant.

The invention also relates to a cement manufacture plant with a furnace system, in particular a rotary furnace, a filter system for dedusting flue gases and preferably a preheating tower.

During the manufacturing of cement, the resulting flue gases are filtered using filter systems, thereby dedusted. Filter systems can be used at various points in cement manufacture plants, for example upstream of a catalyser, when viewed in the direction of flow of the flue gases, or in a bypass. The accumulated dust produced during filtering typically passes through a discharge opening of the filter device to the outside and is usually conveyed from there to a collection point by a screw conveyor or other conveying device.

In state-of-the-art filter systems, ambient air can enter the cement manufacture plant via the discharge opening, which can have a negative effect on the cement manufacture process. This is particularly the case if there is negative pressure in the filter system. In novel cement manufacture processes, in which combustion is carried out with oxygen-enriched air or pure oxygen instead of ordinary ambient air in order to obtain CO2 that is as pure as possible as exhaust gas, which can be reused for other processes, the introduction of ambient air can be disadvantageous because the CO₂ content produced during combustion is reduced as a result. It would therefore be desirable to minimise the input of ambient air-the so-called false air input-in such processes. The state of the art therefore endeavours to make all system components as airtight as possible. However, necessary system openings, such as the discharge openings of the filter devices, continue to pose a problem because they still allow ambient air to enter the system.

A rotary feeder is known from EP 1 344 732 A1, in which a sealing gas opening is arranged in the area of the housing around the rotary valve, in particular on the casing wall of the housing, in order to minimise the (process) gas flow through the rotary feeder. A disadvantage of the rotary feeder of EP 1 344 732 A1 is that a large amount of sealing gas and large gap widths between the rotary valve and the housing are required in order to minimise the (process) gas flow through the rotary feeder.

GB 2 271 114 A discloses a method for expelling unpolymerised monomers from polymer compounds, in which polymerised resin is conveyed alternately into vacuumed and pressurised areas via rotary feeders. The vacuum harbours the risk of ambient air being sucked in via system openings.

CN 103625929 B discloses an arrangement of rotary feeders, between which, however, ambient air is introduced in order to avoid negative pressure in a consecutive part of the system, a material storage tank.

In the light of the above, it is the task of the present invention to eliminate or at least alleviate the disadvantages of the prior art. Preferably, it is the task of the present invention to reduce or even completely avoid the introduction of false air via a discharge opening of a filter system in a cement manufacture plant.

This task is solved by a method according to claim 1, by a filter system according to claim 10 and by a cement manufacture plant according to claim 14. Preferred embodiments are given in the dependent claims.

According to the invention, in a method of the type mentioned at the beginning, it is provided that two lock devices connected in series, in particular rotary valves, are connected to the discharge opening, said lock devices being connected to one another via a connecting element, in particular a connecting pipe, and transporting the accumulated dust from the discharge opening to the outside, wherein a sealing gas inlet opens into the connecting element between the lock devices and a sealing gas is introduced into the connecting element in order to block the penetration of ambient air into the filter device. “Connected in series” means that accumulated dust passes from one lock device to the other. Advantageously, by introducing the sealing gas into the connecting element that connects the lock devices to each other, the unwanted entry of ambient air can be greatly reduced or prevented because the sealing gas penetrates to the outside via any leaks and in this way displaces the ambient air. If there is a negative pressure in the filter device, only the sealing gas is sucked in, but not the ambient air. A filter system comprises at least one filter device, two lock devices connected to it, the connecting element and the sealing gas inlet. The connecting element, which is preferably designed as a connecting pipe, preferably connects the housings of the two lock devices to each other in a gas-tight manner. For this purpose, two opposite ends of the connecting element are each connected to the lock devices. Accumulated dust that has been filtered out of the flue gas using the filter device can pass through the connecting element from one lock device to the other and from there to the outside. One of the lock devices—referred to below as the first lock device—is connected, preferably in a gas-tight manner, to the discharge opening of the filter device on its inlet side via a connecting part and on its outlet side, preferably in a gas-tight manner, to the connecting element. The other lock device at the other end of the connecting element—referred to below as the second lock device—is connected, preferably in a gas-tight manner, to the connecting element on its inlet side and conveys the dust outwards through its outlet side, i.e. to a point outside the filter system where the dust can be collected, removed and/or further processed. The outlet side of the first lock device is thus connected to the inlet side of the second lock device via the connecting element, so that dust can be carried from the filter device to the outside via the first lock device, the connecting element and then via the second lock device. The first lock device represents the process-side lock device, while the second lock device represents the atmosphere-side lock device. The lock devices can be designed in particular as rotary valves. Rotary valves have a fixed housing (stator) and a rotatable rotary wheel (rotor), which is preferably driven by an electric motor. Rotary valves take in material on one input side and release it in a dosed form on the output side. Only a small gap of preferably less than 1 mm is provided between the walls of the rotary wheel and the housing in order to ensure tightness between the input side and the output side. However, rotary valves cannot be completely tight due to the gap and ambient air is also conveyed into the cement manufacture plant through the rotor cells rotated from the outlet side to the inlet side. According to the invention, the sealing gas is therefore introduced into the connecting element between the rotary valves, which displaces the ambient air or blocks the ambient air from entering and spreading. In particular, ambient air that enters via the second, atmosphere-side lock device is displaced or blocked in this way. The sealing gas inlet may comprise a valve. The valve can also be arranged in a line for the sealing gas. In this way, the sealing gas can be regulated. The sealing gas inlet preferably opens into an inner wall of the connecting element. Several sealing gas inlets can also be provided, which open into the connecting element. The filter system may comprise several filter devices connected in parallel or in series. Each filter device may also comprise several discharge openings, to each of which lock devices, which are connected via a connecting element, are connected as described. The filter device may in turn comprise one or more filters within a housing, which may be candle filters or bag filters, for example. The cement manufacture plant comprises at least one furnace system and a filter system according to the invention for filtering flue gases. In addition, the cement manufacture plant may comprise plant components such as a preheating stage, in particular a preheating tower, a catalyser and one or more bypasses. The filter system with the filter device, the two connected lock devices and the connecting element can be provided at several points in the cement manufacture plant. For example, the filter system can be arranged downstream of the furnace system or downstream of a preheating stage upstream of the furnace, as viewed in the direction of flow of the flue gases, in order to filter flue gases from the furnace system or the preheating stage. Additionally or alternatively, the filter system can also be used to dedust a bypass in the cement manufacture plant. The furnace system of the cement manufacture plant is preferably a rotary furnace. The raw materials for producing the cement clinker are fired or sintered in the furnace system. In a particularly preferred cement manufacture process, oxygen-enriched air or substantially pure oxygen is used for combustion in the furnace system in order to obtain the purest possible CO₂. As mentioned above, a preheating stage may also be provided to preheat the raw materials before they enter the rotary furnace. The preheating stage can be a preheating tower, for example, which can consist of several cyclones arranged one above the other. The raw materials enter the furnace system according to the counterflow principle. The flue gases flow against the flow of raw materials through the preheating stage.

It is preferable if CO₂ or a process gas with a volume fraction of CO₂ of at least 15%, preferably at least 70 %, is used as the sealing gas. As mentioned above, air enriched with oxygen or even pure oxygen can be burnt instead of ordinary ambient air during cement manufacturing in order to obtain CO₂ that is as pure as possible as exhaust gas. In such a cement manufacture process, CO₂ as a sealing gas is therefore not an extraneous gas, so that there is no negative influence from the use of CO₂ as a sealing gas. The process gas used to provide the sealing gas is preferably a furnance exhaust gas, which is preferably cleaned and/or treated before being used as sealing gas.

In one embodiment, the sealing gas can be fed into the connecting element from the furnace system and/or from a sealing gas supply, in particular from at least one gas tank. If oxygen-enriched air or substantially pure oxygen is used for combustion in the furnace system, substantially pure CO₂ is produced, which can be used as sealing gas. In any case, it is not an extraneous gas. A connecting line from the furnace system to the filter system can be used for this purpose. Additionally or alternatively, the sealing gas can also come from a separate sealing gas supply, for example a gas tank or pressurised cylinders.

In order to prevent ambient air from entering the filter system, it is preferable for the sealing gas to be introduced at a pressure of 1 mbar to 200 mbar, preferably 10 mbar to 100 mbar, in particular 30 mbar to 50 mbar, above the static ambient pressure outside the connecting element. The pressure is not set too high in order to avoid damage to the pipe and lock parts due to overpressure and to minimise the consumption of sealing gas.

To facilitate the discharge of the dust, the connecting element between the lock devices can be arranged at an angle to the horizontal, preferably substantially vertically, and one of the lock devices can be arranged above the other. As a result, the dust is carried downwards by gravity.

Unless otherwise stated, indications of direction in this disclosure refer to the inertial system and the state of use of the filter system. Substantially vertical means substantially parallel to the acceleration due to gravity. A horizontal line is substantially transverse to the acceleration due to gravity.

Ambient air can mainly enter via the second, lower lock device. It is therefore advantageous if the inlet side of the second, lower lock device is constantly covered with dust, because the dust has a sealing effect. In one embodiment, it can therefore be provided that a filling level measuring device measures a filling level of the accumulated dust in the connecting element. In this way, the tightness can also be supported. In one embodiment, a measuring sensor can monitor a lower or minimum filling level. A signal can be output if the lower or minimum filling level is exceeded or not reached. A further measuring sensor can also be provided, which measures an upper or maximum filling level. A signal can be output when the upper filling level is reached.

In order to ensure tightness and prevent the entering of ambient air, it may be provided that a control device regulates that lock device, which is arranged at an end of the connecting element facing away from the filter device, in particular its speed, in such a way that a minimum filling level of the accumulated dust is maintained in the connecting element. The lock device, which is arranged at an end of the connecting element facing away from the filter device, is also referred to as the second lock device, as already mentioned above. In one embodiment, the speed of the second lock device can be reduced or the second lock device can be brought to a standstill when the filling level falls below the minimum filling level. When the minimum filling level is reached or exceeded, the speed of the second lock device can be increased again. The minimum filling level may, for example, correspond to a lower section of the connecting element. For example, the minimum filling level may correspond to a quarter of the length of the connecting element. If, as described above, an upper or maximum filling level is also measured, the speed of the lock device can be increased in order to reduce the filling level.

In order to further improve the tightness, at least one shaft seal of at least one lock device can be pressurised with sealing gas. In a preferred design of the lock device as a rotary valve, shaft seals can be provided on both sides of a shaft passage through a housing of the rotary valve. Preferably, an intermediate space between the two shaft seals is pressurised with the sealing gas, in particular a pressurised gas. This prevents ambient air from entering the system because the intermediate space is pressurised to a higher pressure than the process or atmospheric pressure. This means that only (harmless) sealing gas can enter the process or escape to the outside.

The task is also solved by a filter system according to claim 10. The features and advantages described above in connection with method for cement manufacturing are also transferable to the filter system.

The filter system according to the invention for dedusting flue gas of a cement manufacture plant comprises:
a filter device with a discharge opening for accumulated dust;
two lock devices, in particular rotary valves, connected in series and connected to the discharge opening, said lock devices being connected to one another via a connecting element and being set up to convey accumulated dust; and
a sealing gas inlet, which opens into the connecting element.

The filter device comprises a housing which forms the discharge opening and within which one or more filters, in particular bag filters or candle filters, are arranged. The filter device may also comprise several discharge openings in the housing, to each of which lock devices are connected as described. The filter system may also comprise several filter devices. The connecting element is preferably in the form of a connecting pipe. “Connected in series” means that accumulated dust passes from one lock device to the other.

Preferably, a filling level measuring device is provided, which is set up to measure a filling level of the accumulated dust in the connecting element. As already described above, this is advantageous because the dust has a sealing effect, especially when it is in contact with the second lock device. The filling level measuring device can therefore support the tightness. The filling level measuring device can comprise one or more measuring sensors. A lower measuring sensor can measure a lower or minimum filling level. An upper measuring sensor can measure an upper or maximum filling level.

In addition, a control device can be provided and set up to control that lock device, which is arranged at an end of the connecting element facing away from the filter device, in particular its speed, in such a way that a minimum filling level of the accumulated dust is maintained in the connecting element. This can ensure improved tightness.

It is favourable if the filter device is designed to be substantially gas-tight, with the exception of an inlet for the flue gas, an outlet for the flue gas and the discharge opening for accumulated dust, and one of the lock devices is connected to the discharge opening in an substantially gas-tight manner via a connecting part. The gas-tightness can be achieved, for example, by using seals.

The task is also solved by a cement manufacture plant according to claim 14. The cement manufacture plant comprises at least one furnace system, in particular a rotary furnace, a filter system for dedusting flue gases and preferably a preheating tower. According to the invention, the filter system is designed as described above.

In order to introduce the sealing gas into the connecting element, the sealing gas inlet can be connected to the furnace system, depending on the design, either directly or via a gas treatment and/or gas cleaning system, and/or a sealing gas supply, in particular a gas tank.

### BRIEF DESCRIPTION OF THE FIGURES

In the following, the invention is described in more detail with reference to figures, to which, however, it is not intended to be limited. It shows:

FIG. 1 a schematic view of a cement manufacture plant; and

FIG. 2 a schematic view of a filter system with two lock devices that are connected to each other via a connecting element.

### DETAILED DESCRIPTION

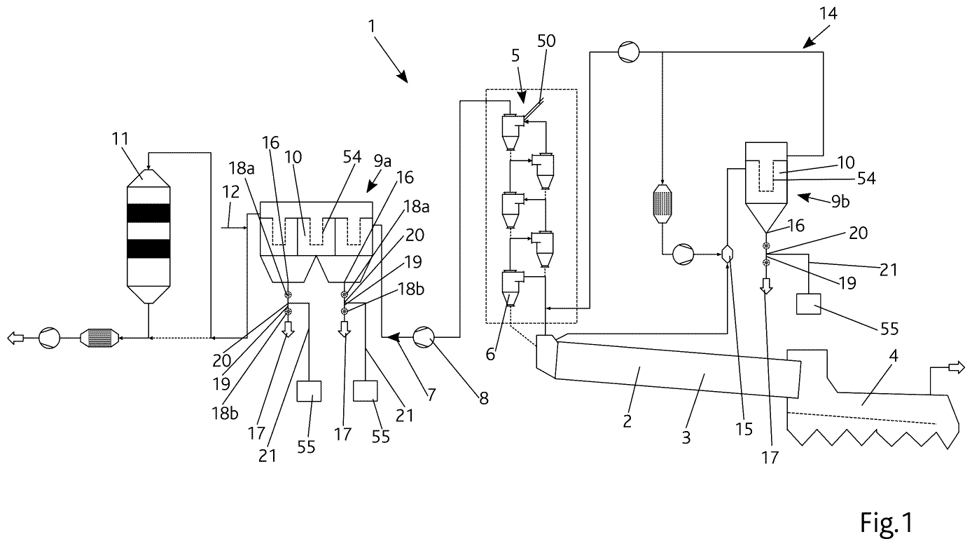

FIG. 1 shows a cement manufacture plant 1 with a furnace system 3 designed as a rotary furnace 2, to which a clinker cooler 4 is connected. In the rotary furnace 2, raw materials (not shown) are fired to form cement clinker (not shown) and then cooled in the clinker cooler 4. Oxygen-enriched air or substantially pure oxygen is preferably used in the combustion process, so that the combustion produces substantially pure CO₂, which can be further processed or used for other processes. The raw materials are preheated in a preheating tower 5 before they are fed to the rotary furnace 2. The rotary furnace 2 is arranged between the clinker cooler 4 and the preheating tower 5. The preheating tower 5 consists of a plurality of interconnected cyclones 6. According to the counterflow principle, the raw materials from a material feed 50 pass through the preheating tower 5 into the rotary furnace 2, whereas the furnance exhaust gases or flue gases 7 produced during combustion flow against the flow of raw materials through the preheating tower 5. Seen in the direction of the flue gases 7, the preheating tower 5 is therefore located after the furnace system 3. The raw materials are heated up to 800 °C and transported in the direction of the rotary furnace 2. At the same time, the flue gas 7 is cooled from approx. 850 °C to between 300 °C and 400 °C. Before the raw materials enter the rotary furnace 2, a so-called calciner (not shown) is installed in modern plants, which has a separate firing system and has the task of deacidifying the limestone through high temperatures and sufficient dwell time. In rotary furnace 2, the raw materials are heated further and finally sintered into clinker at material temperatures of up to 1600 °C, forming typical clinker phases (calcium-aluminium silicates).

From the preheating tower 5, the flue gas 7 then passes via a fan 8 into a first filter system 9a (“furnace filter system”) with at least one filter device 10, with which the flue gas 7 is dedusted. The dedusted flue gas 7 then passes into a catalytic converter 11 for converting nitrogen oxides NOx into harmless compounds. A reducing agent, for example a substance containing ammonia, urea and/or ammonium, is introduced via an inlet 12 before the flue gas 7 enters the catalytic converter 11. The dedusted and filtered flue gas 7 is then discharged to the outside via a heat exchanger and a chimney (not shown).

The cement manufacture plant 1 shown also comprises a bypass branch 14, with which part of the flue gas 7 from the rotary furnace 2 is not fed directly into the preheating tower 5, but from a rotary furnace inlet chamber through a quench 15, another filter system 9b (“bypass filter system”) with a filter device 10 and back into the transition area between rotary furnace 2 and preheating tower 5. The bypass branch 14 is used to remove alkali and alkaline earth metal halides from the process.

For various reasons, it can be disadvantageous for the cement manufacture process if ambient air is introduced into the cement manufacture plant 1. This is particularly disadvantageous, for example, if oxygen-enriched air or pure oxygen is used in the combustion process in the rotary furnace 2 in order to obtain CO₂ that is as concentrated as possible. The introduction of ambient air or false air can reduce the efficiency and lower the concentration of CO₂, which can be unfavourable for the further use of the CO₂. False air can enter the cement manufacture plant 1 for example via discharge openings 16 of the filter systems 9a, 9b, which are intended to transport the dust filtered from the flue gas 7 out of the filter systems 9a, 9b to a collection point 17.

In order to prevent ambient air from entering the cement manufacture plant 1 via the discharge openings 16, the invention provides for two lock devices 18a, 18b connected in series to the discharge openings 16, which are connected to each other via a connecting element 19. Between the lock devices 18a, 18b, a sealing gas inlet 20 opens into the connecting element 19, through which a sealing gas 21 is introduced into the connecting element 19 in order to block the penetration of ambient air. The sealing gas 21 penetrates to the outside via any leaks and openings (or is conveyed to the outside together with the dust) and thus displaces the ambient air penetrating via leaks and mainly the lock device 18b, as will be described in more detail below. In FIG. 1, two such lock devices 18a, 18b with an intermediate sealing gas inlet 20 are connected to all discharge openings 16 of the filter system 9a and the filter system 9b. The sealing gas 21 can be provided via connecting lines from the furnace system 3 (not shown) or, as shown in FIG. 1, from gas tanks 55. A valve 56 can regulate the sealing gas 21.

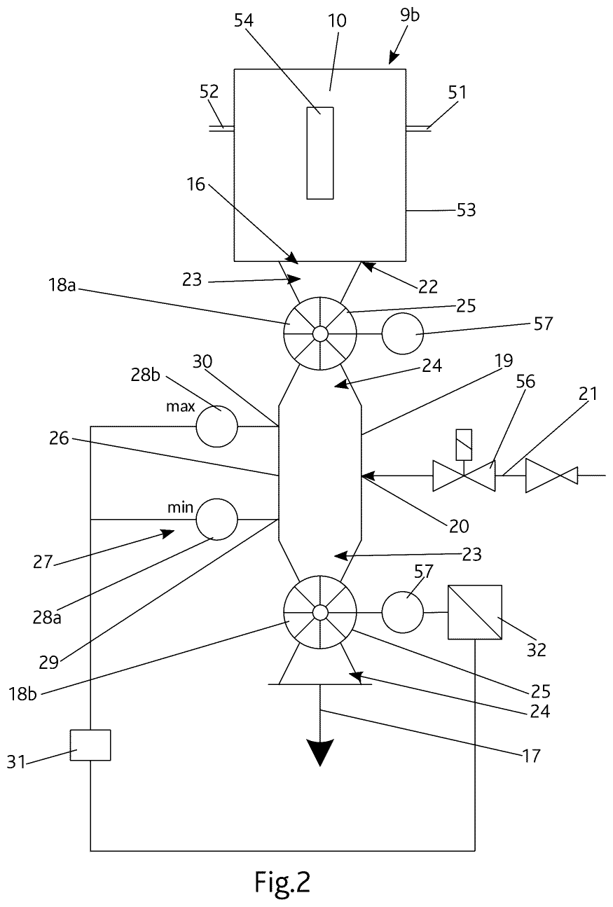

FIG. 2 shows the filter system 9b in detail. The filter system 9a is larger, but of the same design, except for the difference that two discharge openings 16 are provided and two lock devices 18a, 18b connected in series and connected via a connecting element 19 are arranged at each discharge opening 16 with a sealing gas inlet 20 in between. The filter device 10 has an inlet 51 and an outlet 52 for the flue gas 7. The filter device 10 has a housing 53, within which at least one filter 54 is arranged.

In FIG. 2 it can be seen that the discharge opening 16 is arranged on an underside 22 of the housing 53 of the filter device 10, to which an input side 23 of the lock device 18a is connected. The lock device 18a is also referred to as the first or upper lock device 18a. Connected to an output side 24 of the first lock device 18a is the connecting element 19, which connects the first lock device 18a to the input side 23 of the lock device 18b, which is also referred to as the lower or second lock device 18b. The lock devices 18a, 18b are designed as rotary valves 25. The lock devices 18a, 18b can be driven by means of electric motors 57. In the illustration shown, the connecting element 19 is a straight connecting pipe 26. Dust passes from the filter device 10 via the discharge opening 16 into the first lock device 18a, through the connecting element 19 into the second lock device 18b and from there to the collection point 17. The connecting element 19 is arranged substantially vertically so that accumulated dust is transported by gravity from the first lock device 18a to the second lock device 18b. The sealing gas inlet 20 opens into an inner wall of the connecting element 19. Several sealing gas inlets 20 can also be provided.

In order to reduce or prevent the ingress of ambient air, all connection points between the components of the filter system 9b are designed to be gas-tight. However, ambient air can still penetrate via the outlet side 24 of the second lock device 18b. To prevent this, the sealing gas 21 is introduced into the connecting element 19 at a pressure above the ambient pressure, for example at 1.04 bar. The sealing gas 21 displaces the penetrating ambient air and pushes it outwards (again). Sealing gas also escapes to the outside via the second lock device 18b. CO₂ is preferably used as sealing gas 21. The use of CO₂ as sealing gas 21 is particularly advantageous if oxygen-enriched air or substantially pure oxygen is used in the rotary furnace 2, whereby substantially pure CO₂ is produced during the combustion process. This means that CO₂ is not an extraneous gas for the process.

In order to further increase the tightness, it is favourable if dust is always present at the inlet side 23 of the second lock device 18b. For this reason, it is favourable if the filter system 9a, 9b comprises a filling level measuring device 27 which measures the filling level of the accumulated dust in the connecting element 19. In the illustration shown, the filling level measuring device 27 comprises a lower measuring sensor 28a and an upper measuring sensor 28b. The lower measuring sensor 28a can be used to detect a minimum filling level 29. The upper measuring sensor can be used to detect a maximum filling level 30. When the maximum filling level 30 is reached, countermeasures can be taken. For example, there may be a defect that needs to be rectified. The speed of the second lock device 18b can also be increased in order to remove the dust. In any case, a warning can be issued. A control device 31 can control the speed of the second lock device 18b, preferably with the aid of an inverter/frequency converter 32, which controls the electric motor 57, in such a way that the minimum filling level 29 is always present in the connecting element 19. If, for example, the filling level is lower than the minimum filling level 29, the speed of the lower lock device 18b can be reduced or it can be brought to a standstill, at least until the minimum filling level 19 is present again.

1. Method for discharging dust from a filter system in a cement manufacture plant, in which raw materials for the production of cement are fired in a furnace system, flue gas produced is dedusted in the filter system with a filter device and accumulated dust is discharged via a discharge opening of the filter device, wherein two lock devices, are connected in series to the discharge opening, said lock devices being connected to each other via a connecting element, and transporting the accumulated dust from the discharge opening to the outside, wherein a sealing gas inlet opens into the connecting element between the lock devices and a sealing gas is introduced into the connecting element in order to block the penetration of ambient air into the filter device.

2. Method according to claim 1, wherein CO₂ or a process gas with a volume fraction of CO₂ of at least 15%, is used as sealing gas.

3. Method according to claim 1, wherein the sealing gas is fed into the connecting element from the furnace system and/or from a sealing gas supply.

4. Method according to claim 1, wherein the sealing gas is introduced at a pressure of 1 mbar to 200 mbar above the static ambient pressure outside the connecting element.

5. Method according to claim 1, wherein the connecting element between the lock devices is arranged at an angle to the horizontal, and one of the lock devices is arranged above the other.

6. Method according to claim 1, wherein a filling level measuring device measures a filling level of the accumulated dust in the connecting element.

7. Method according to claim 6, wherein a control device regulates that lock device which is arranged at an end of the connecting element facing away from the filter device, in such a way that a minimum filling level of the accumulated dust is maintained in the connecting element.

8. Method according to claim 1, wherein at least one shaft seal is acted upon by at least one lock device with sealing gas.

9. Method according to claim 1, wherein oxygen-enriched combustion air or substantially pure oxygen is used for combustion in the furnace system.

10. Filter system for dedusting flue gas of a cement manufacture plant, comprising:
at least one filter device with a discharge opening for accumulated dust;
two lock devices, connected in series and connected to the discharge opening, said lock devices being connected to one another via a connecting element and being set up to convey accumulated dust; and
a sealing gas inlet, which opens into the connecting element.

11. Filter system according to claim 10, wherein a filling level measuring device is provided, which is set up to measure a filling level of the accumulated dust in the connecting element.

12. Filter system according to claim 11, wherein a control device is provided and set up to control that lock device which is arranged at an end of the connecting element facing away from the filter device, in such a way that a minimum filling level of the accumulated dust is maintained in the connecting element.

13. Filter system according to claim 10, wherein the filter device, with the exception of an inlet for the flue gas, an outlet for the flue gas and the discharge opening for accumulated dust, is substantially gas-tight and one of the lock devices is connected to the discharge opening in a substantially gas-tight manner via a connecting part.

14. Cement manufacture plant with a furnace system, a filter system for dedusting flue gases, wherein the filter system is designed according to claim 10.

15. Cement manufacture plant according to claim 14, wherein the sealing gas inlet is connected to the furnace system and/or a sealing gas supply.

16. Method according to claim 1, wherein the two lock devices are rotary valves, and the connecting element is a connecting pipe.

17. Method according to claim 2, wherein the volume fraction of CO₂ is at least 70%.

18. Method according to claim 4, wherein the pressure is 30 mbar to 50 mbar above the static ambient pressure outside the connecting element.

19. Method according to claim 6, wherein the connecting element is arranged substantially vertically.

20. Method according to claim 7, wherein the control device regulates a speed.
